(19) United States
(12) Patent Application Publication
(10) Pub. No.: US 2003/0197351 A1
(43) Pub. Date: Oct. 23, 2003

(54) Work assist accessory for pallet trucks and pallet trucks including work assist features

(76) Inventors: Jeffrey R. Burger, Bexley, OH (US); Michael P. Gallagher, Greenville, OH (US); Roger J. Quinlan JR., Troy, OH (US); Rainer B. Teufel, Worthington, OH (US); Jeffrey T. DeBord, Worthington, OH (US)

Correspondence Address: STEVENS & SHOWALTER LLP, 7019 CORPORATE WAY, DAYTON, OH, 45459-4238, US

(21) Appl. No.: 10/421,090

(22) Filed: Apr. 23, 2003

Related U.S. Application Data
(60) Provisional application No. 60/374,646, filed on Apr. 23, 2002.

(51) Int. Cl. B62B 1/00

(52) U.S. Cl. 280/651

(57) ABSTRACT

Work assist features are provided as a retrofit product to extend the functionality/capabilities of existing hand/powered pallet trucks and also in new trucks including the work assist features. An extension is attached to a truck body near the base of the forks to support a work tray with the tray being mounted for adjustable vertical positioning and being pivotal to move between a use position over forks of the truck and a stowed position out of the way of the forks. The extension can provide for mounting pouches and various accessory supports for convenient access by an operator of the truck so that pencils, papers, clipboards, marking devices, scanners, tape, tools and the like can be held in the pouches or accessory supports rather than being carried by the operator or placed on top of a load.

### CROSS REFERENCE TO RELATED APPLICATIONS

This application claims the benefit of U.S. Provisional Patent Application No. 60/374,646 filed Apr. 23, 2002, and entitled WORK ASSIST ACCESSORY FOR A HAND PALLET TRUCK AND A HAND PALLET TRUCK INCLUDING WORK ASSIST FEATURES which is incorporated herein by reference for all purposes.

### BACKGROUND OF THE INVENTION

The present invention relates in general to pallet trucks and, more particularly, to pallet trucks that include work assist™ features and work assist™ accessories that can be added to existing pallet trucks to assist truck operators in performing operations with the trucks.

Hand driven (hand pallet trucks) and power driven (powered pallet trucks) are the most common materials handling vehicles in use today. These trucks are used in a wide variety of businesses involved in product manufacturing, distribution, retailing—generally any business where large products or large packages of products need to be moved around a facility. While larger materials handling vehicles are also commonly used in many of these facilities, in small to medium facilities, hand and powered pallet trucks may be all that is available with only hand pallet trucks being available in the smallest facilities, particularly retail.

A primary purpose for pallet trucks (both hand and powered) as the name implies, is to enable people to move palletized product loads of up to 5000 pounds over relatively short distances. For example, they are used to load and unload pallets from semitrailers. They are also used for a wide variety of other tasks, including moving heavy objects around a facility, order picking, transporting products to retail sales floors, supporting products while they are placed on shelves for display and similar tasks.

Materials handling facilities in general, and retail businesses in particular, require stock throughput to be as fast as possible due to increased supply chain efficiencies that allow more frequent just-in-time replenishment of stock. Retailers are also tending to stock a greater variety of products but in smaller volumes. This trend is to accommodate more divergent tastes of an increasingly fragmented market. These developments have led to greater productivity requirements for the materials handling side of businesses of all sizes. Thus, there is a need for more flexible materials handling vehicles to help businesses better respond to these needs.

### SUMMARY OF THE INVENTION

This need is met by the invention of the present application wherein work assist™ features are provided as a retrofit or add-on product to extend the functionality and capabilities of existing pallet trucks and are also provided in new pallet trucks that include the work assist features.

A pallet truck including the present invention comprises a truck body with elongated forks extending in parallel from the truck body. An extension, such as a framework or mast, is attached to the truck body and projects in a general upright direction adjacent to the back of the truck, i.e., the side of the truck from which the elongated forks extend. A work tray is supported on the extension and projects selectively over the elongated forks or in a generally vertical orientation or stowed position to be clear of the forks. The tray can be moved along the extension or the extension moved relative to the truck to select the height of the tray relative to the truck or forks.

For a hand pallet truck, a generally upright extension is supported at the base of the forks of the truck and extends generally parallel to a handle of the truck when the handle is in its upright position. A work tray is supported on the extension with the tray being mounted for adjustable positioning along the extension and being pivotal to move between a use position over the forks of the truck and a stowed position out of the way of the forks. The extension also provides a location for mounting pouches and various accessory supports so that they are available for convenient access by an operator of the truck. Thus, pencils, clipboards, marking devices, scanners, tape, tools and the like can be held in the pouches or accessory supports rather than being carried by the operator or placed on top of a load being carried by the truck.

While the work tray can be used for placement of such materials needed by the operator, it can also be used to organize and support products that are being moved by the truck. For example, when stock is being placed on shelves for display and sale, an operator can locate the work tray to a convenient height and stock the products from the work tray. Prior to this invention, since loads on pallets vary in height and over time, as products are being removed and placed on shelves, operators had to bend down to reach products or other materials supported on the truck. By using the present invention, loads can be positioned at comfortable work heights so that operators can work from preferred heights selectable by individual operators.

When used for picking orders in distribution centers, the invention of the present application improves and facilitates operator actions by providing a work tray surface that can be used for paperwork, product sorting, labeling, storage and the like. When used for transporting and distributing boxes of products to shelves for display and sale, after transporting boxes of products to a shelf location, an operator can place the boxes on the work tray, open the boxes and distribute the goods to specific locations. Many types of goods need some form of organization, such as folding clothes or towels, or arranging products by stockkeeping unit (SKU) numbers. Thus, the adjustable height folding work tray provides a place to arrange goods before transferring them to shelves.

A number of features and advantages of the invention will be apparent from the following description, the accompanying drawings and the appended claims.

### BRIEF DESCRIPTION OF THE DRAWINGS

FIG. 1 is a perspective view of a first embodiment of the present invention incorporated into a hand pallet truck taken from the back of the truck over the forks and with a work tray shown in solid lines in a high use position and in dotted lines in a low use position;

FIG. 2 is a perspective view of the hand pallet truck of FIG. 1 with the work tray in its stowed position;

FIG. 3 is a perspective view of the hand truck of FIGS. 1 and 2 taken from the front of the truck or from the operator's position with the work tray shown down in a use position;

FIG. 4 is a perspective view of a second embodiment of the present invention in an add-on accessory for existing hand pallet trucks;

FIG. 5 is a perspective view of an illustrative embodiment of the work tray of FIGS. 1-4 and an arrangement for mounting the work tray;

FIG. 5A is a perspective view corresponding to FIG. 5 but with the work tray stowed in its vertical storage position;

FIG. 6 is a partially sectioned side view of the work tray mounting arrangement of FIG. 5;

FIG. 7 is an exploded view of the work tray and work tray mounting arrangement of FIG. 5 with some parts removed for sake of clarity of illustration;

FIG. 8 is an exploded view of an elevator assembly of the work tray mounting arrangement as viewed from the central panel taken along the view line 8-8 of FIG. 7;

FIG. 9 is a perspective view of a third embodiment of the present invention incorporated into a powered pallet truck, a walkie stacker pallet truck, taken from the back of the truck over the forks and with a work tray shown in a highest use position;

FIG. 10 is a perspective view of the embodiment of FIG. 9 detached from the powered truck body, the view taken from the back of the powered pallet truck and with the work tray in its stowed position;

FIG. 11 is a perspective view of the embodiment of FIG. 9 from the front of the truck or from the operator's position with the work tray shown in a highest use position;

FIG. 12 is a partially sectioned side view of a pivoting mechanism for the work tray of FIGS. 9-11 with the work tray in its highest use position;

FIG. 13 is a partially sectioned side view of the pivoting mechanism for the work tray similar to FIG. 12 but with the work tray being pivoted upward for repositioning;

FIG. 14 is a partially sectioned front view of the pivoting mechanism of FIG. 12 taken along the view line 14-14 of FIG. 12;

FIG. 15 is a partially sectioned side view of the pivoting mechanism of FIGS. 12-14 with the work tray shown in its generally vertical, stowed position;

FIG. 16 is a partially sectioned side view of the pivoting mechanism of FIGS. 12-15 taken along the section line 16-16 of FIG. 15;

FIG. 17 is a partially sectioned view of a work tray spring stop taken along the section line 17-17 of FIG. 10;

FIG. 18 is a perspective view of a fourth embodiment of the present invention incorporated into a powered pallet truck, a walkie pallet truck, taken from the back of the truck over the forks and with a work tray shown in its stowed position;

FIG. 19 is a perspective view of the powered pallet truck of FIG. 18 again taken from the back of the truck but with the work tray raised to a first working position;

FIG. 20 is a plan view of an upper portion of a control mechanism for the work tray of FIG. 19 taken along the view line 20-20 of FIG. 19;

FIG. 21 is a perspective view of the powered pallet truck of FIG. 18 again taken from the back of the truck but with the work tray raised to a second working position above the first working position;

FIG. 22 is a plan view of an upper portion of a control mechanism for the work tray of FIG. 21 taken along the view line 22-22 of FIG. 21; and

FIG. 23 is a sectioned side view of the control mechanism for raising and lowering the work tray of FIGS. 18-22.

### DETAILED DESCRIPTION OF THE INVENTION

Reference will now be made to FIGS. 1-3 that show a hand pallet truck 100 including a first embodiment of the invention of the present application. The truck 100 has elongated forks 102, 104 projecting outwardly in parallel relationship from a frame assembly 106. The frame assembly 106 is connected to a piston rod (not shown) of a hydraulic assembly 108 that is connected to and supported by an axle 110 to which wheels 112, 114 are rotatably mounted. The hydraulic assembly 108 is journaled through a traverse 116 for rotation about a vertical axis aligned with the piston rod. The wheels 112, 114 are steered by a handle 118 that is mounted to the hydraulic assembly 108 by a roll pin 120 so that it can be pumped to actuate a hydraulic pump within the hydraulic assembly 108 to move the piston rod. Thus, by moving the handle 118 from side-to-side, the wheels 112, 114 are steered and by moving the handle 118 up and down, the hydraulic pump is actuated and the piston rod is moved to raise the frame assembly 106 and hence the back of the forks 102, 104.

Roller wheels 122, 124 are pivotally attached to the forks 102, 104, respectively and are connected through a rod assembly lifting link subassembly 126. When the handle 118 is moved up and down to actuate the hydraulic pump, the piston rod is moved up lifting the frame assembly 106. At the same time, the lifting link subassembly 126 pivots the connections of the wheels 122, 124 to force the wheels 122, 124 downwardly with respect to the forks 102, 104, thereby lifting the front ends of the forks 102, 104. These actions lift the forks 102, 104 and any pallet or other load positioned on the forks 102, 104 so that the hand pallet truck 100 and any load supported thereon can be moved to a desired location as is well known in the art. The truck as described above is representative of a hand pallet truck for which the present invention is applicable; however, it is to be understood that the invention can be utilized together with other powered pallet trucks as will be described below.

In accordance with the present invention, work assist features are provided as an integral part of the hand pallet truck 100 or can be provided as an add-on product, see below, to extend the functionality and capabilities of existing hand pallet trucks. In the embodiment illustrated in FIGS. 1-3, a generally upright extension 130 is supported by the frame assembly 106. The extension 130 can be integrally formed with the framework 132 or secured to the framework 132 comprises an outer tubular framework 132 having a central panel 134 secured between a major portion of the tubular framework 132 and extending between a base 136 and an open arched portion 138. As illustrated, the extension 130 is oriented at approximately the same angle as that of the handle 118 so that it is generally parallel to the handle 118 when the handle 118 is in its upright position. However, other upright angular orientations of the extension 130 are contemplated for use in the present invention.

A work tray 140 is supported on the central panel 134 of the extension 130 with the tray 140 being mounted for adjustable vertical positioning along the extension 130 as illustrated by showing the tray 140 in solid lines in a high position and in dotted lines in a low position. It is to be understood that the work tray 140 can be positioned in a variety of positions between the illustrated high and low positions. In the illustrated embodiments, the work tray 140 can be positioned at a number of stepped or incremental locations along the extension 130; however, the present invention contemplates a continuously positionable mounting arrangement for the tray 140.

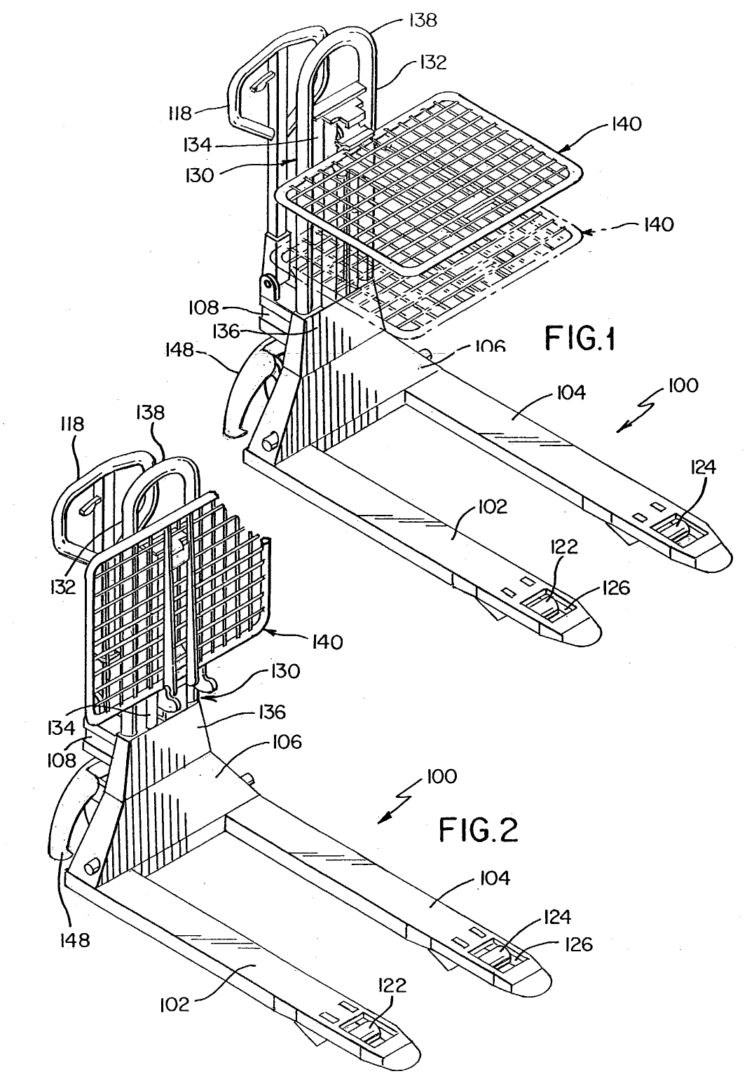

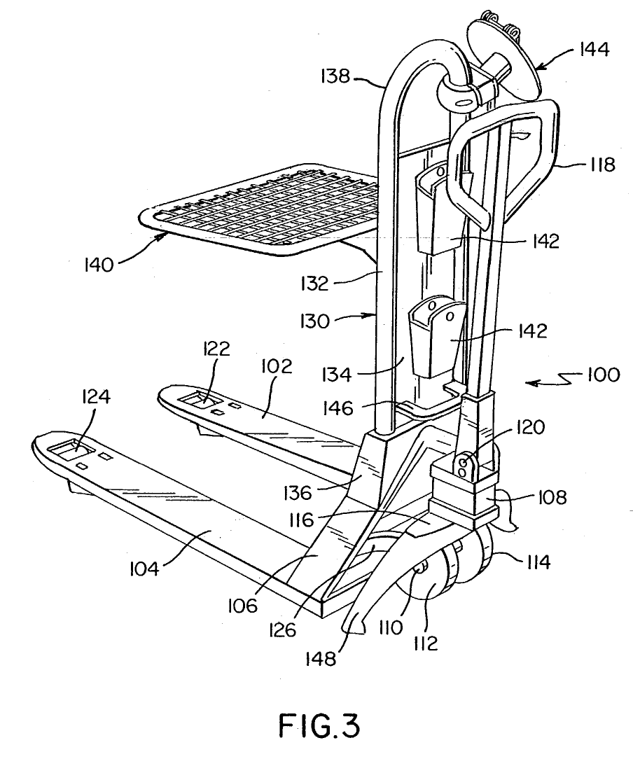

The illustrated work tray 140 is also mounted to be pivotally moved between use positions over the forks 102, 104 of the truck 100, as shown in FIG. 1, and a stowed position out of the way of the forks 102, 104, as shown in FIG. 2. The extension 130 also provides a location for mounting item retention apparatus such as pouches 142 or other hooks, boxes, brackets and the like. Such support structures mounted on the extension 130 are readily available for convenient access by an operator of the truck 100, see FIG. 3. Item retention apparatus taking the form of add-on accessories can also be mounted to the tubular framework 132, particularly in the open arched portion 138. As an example, a universal clip pad and hook 144 is shown as being secured to the tubular framework 132. Thus, pencils, papers, clipboards, marking devices, scanners, tape, tools and the like can be held in the item retention apparatus, such as the pouches 142, or by accessories rather than being carried by the operator or placed on top of a load being carried by the truck 100.

To keep the handle 118 spaced from the extension 130 and work tray 140, currently a deflector 146 made from cast steel, is secured to the central panel 134. Other constructions of the deflector 146 and mounting locations, such as on the handle 118, will be suggested to those skilled in the art by the present disclosure. To help stabilize the truck 100 in the event an off-center load is placed on the tray 140, a stabilizer 148 is secured to the traverse 116 or to another appropriate portion of the truck 100. The stabilizer 148 of the illustrated embodiments are shown as being cast; however, other constructions can be used in the present invention.

The work tray 140 can be used for placement of the items noted above needed by the operator while using the truck 100, it can also be used to organize and support products that are being moved by the truck 100. For example, when stock is being placed on shelves for display and sale, an operator can locate the work tray 140 to a convenient height and stock the products from the work tray 140. When used for picking orders, the invention of the present application improves and facilitates operator actions by providing a work surface on the tray 140 that can be used for paperwork, product sorting, labeling, storage and the like. When used for transporting and distributing boxes of products to shelves for display and sale, after transporting boxes of products to a shelf location, an operator can place the boxes on the work tray 140, open the boxes and distribute the goods to specific locations. Many types of goods need some form of organization, such as folding clothes or towels, or arranging products by SKU numbers. Thus, the adjustable height, folding work tray 140 provides a convenient place to arrange goods before transferring them to shelves.

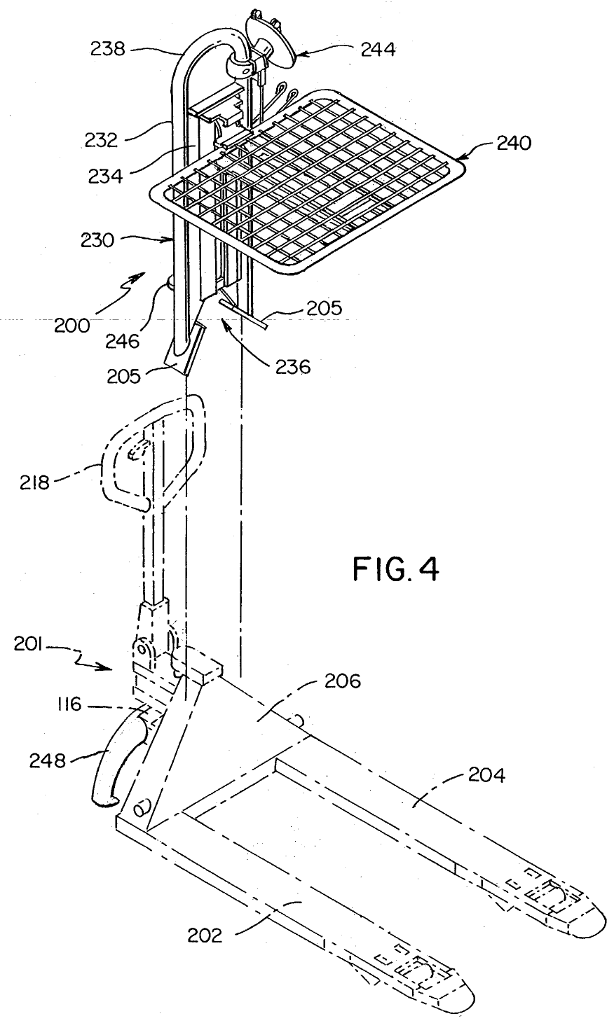

FIG. 4 illustrates a second embodiment of the present invention that comprises an add-on accessory 200 for existing hand pallet trucks, such as the dotted line hand pallet truck 201. As illustrated, a generally upright extension 230 comprises an outer tubular framework 232 having a central panel 234 secured between a major portion of the tubular framework 232 and extending from an inverted v-shaped base area 236 and an open arched portion 238. In this embodiment, the add-on accessory 200 is secured to the base of a hand pallet truck 202, for example to a frame assembly such as the frame assembly 206, by mounting structure, plates 205 as illustrated, secured to the lower ends of the tubular framework 232 by bolts, welding, clamps or other appropriate means and oriented to be received by the appropriate structure of a truck, for example the frame assembly 206. Other mounting arrangements, such as brackets and the like, are contemplated for use in the present invention. As illustrated, the extension 230 is oriented at approximately the same angle as the handle 218 so that it is generally parallel to the handle 218 when the handle 218 is in its upright position. However, other upright angular orientations of the extension 230 are contemplated for use in the present invention.

A work tray 240 is supported on the central panel 234 of the extension 230 with the tray 240 being mounted for adjustable vertical positioning along the extension 230, similar to that disclosed above with regard to FIGS. 1-3. The work tray 240 is also mounted to be pivotally moved between use positions over the forks 202, 204 of the truck 201 shown in FIG. 4, comparable to FIG. 1, and a stowed position (not shown) out of the way of the forks 202, 204, see FIG. 2. The extension 230 also provides a location for mounting pouches 242 and various other accessories so that they are available for convenient access by an operator of the truck 201, also see FIG. 3. Item retention apparatus taking the form of add-on accessories can also be mounted to the tubular framework 232, particularly in the open arched portion 238. As an example, a universal clip pad and hook 244 is shown as being secured to the tubular framework 232. Thus, pencils, papers, clipboards, marking devices, scanners, tape, tools and the like can be held in the pouches or by accessories rather than being carried by the operator or placed on top of a load being carried by the truck 201. To keep the handle 218 spaced from the extension 230 and work tray 240, currently a deflector 246 made from cast steel is secured to the central panel 234. Other constructions of the deflector 246 and mounting locations, such as on the handle 218, will be suggested to those skilled in the art by the present disclosure. To help stabilize the truck 201 in the event an off-center load is placed on the tray 240, a cast stabilizer 248 can be secured to the truck 201, for example to a traverse 116 as shown in FIG. 3 or to other appropriate structure depending upon the particular truck to which the add-on accessory 200 is being mounted.

The work tray 240 can be used for placement of the items noted above needed by the operator while using the truck 201, it can also be used to organize and support products that are being moved by the truck 201. For example, when stock is being placed on shelves for display and sale, an operator can locate the work tray 240 to a convenient height and stock the products from the work tray 240. When used for picking orders, the invention of the present application improves and facilitates operator actions by providing a work surface on the tray 240 that can be used for paperwork, product sorting, labeling, storage and the like. When used for transporting and distributing boxes of products to shelves for display and sale, after transporting boxes of products to a shelf location, an operator can place the boxes on the work tray 240, open the boxes and distribute the goods to specific locations. Many types of goods need some form of organization, such as folding clothes or towels, or arranging products by SKU numbers. Thus, the adjustable height folding work tray 240 provides a place to arrange goods before transferring them to shelves or other display/support structures.

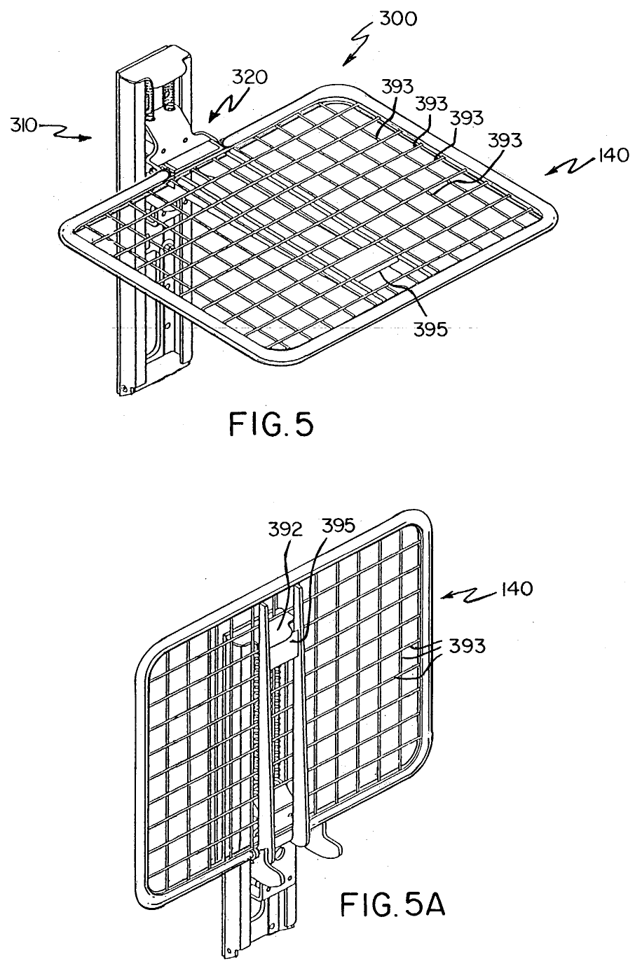

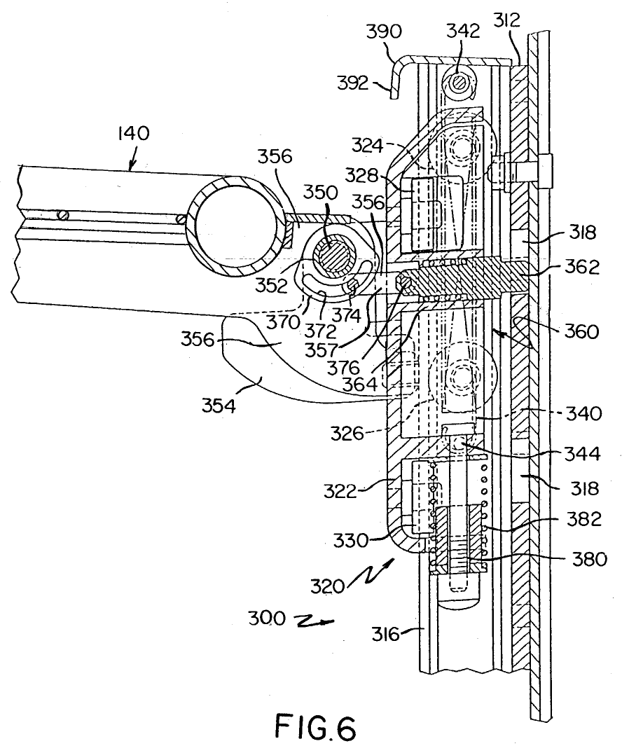

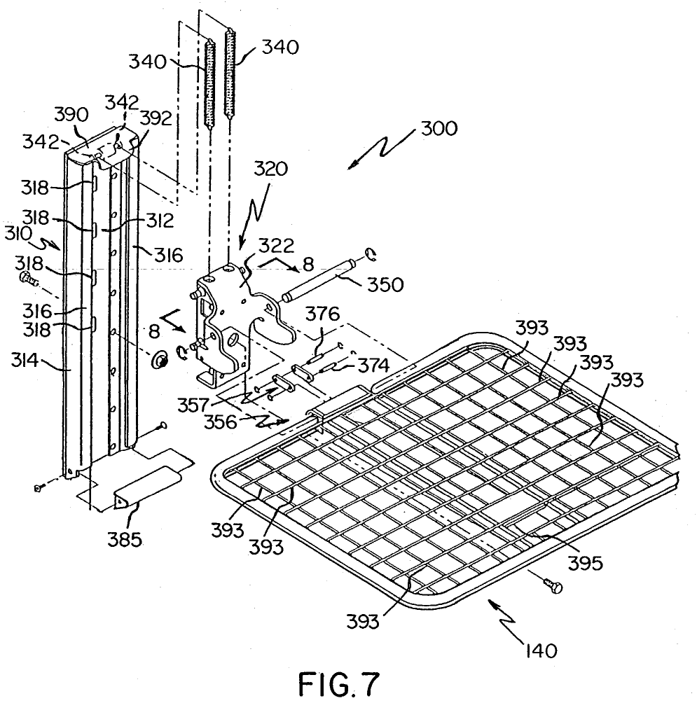

Reference is now made to FIGS. 5, 5A and 6-8 which illustrate a currently preferred embodiment of the work tray 140 of the embodiments of the invention shown in FIGS. 1-4, however, other work tray designs are contemplated for use in the invention. The work tray 140 is shown connected to an attachment mechanism 300 that is in turn connected to the central panel 134. The attachment mechanism 300 includes a C-shaped member 310, an elevator or elevator assembly 320, and a back wall member 312, side wall members 314 and a pair of partial front wall members 316. The back wall member 312 includes several spaced apart openings or slots 318.

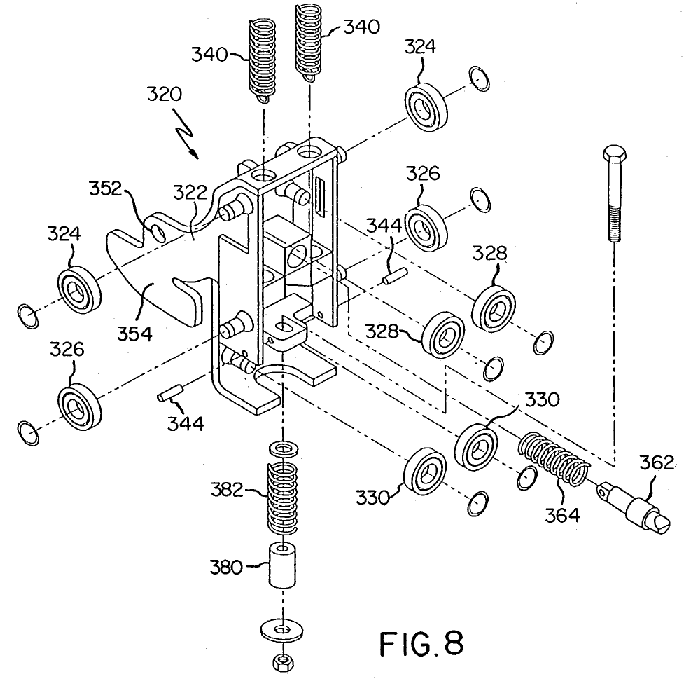

As shown in FIG. 8, the elevator assembly 320 includes a main frame member or plate 322 that has mounted thereon several rollers, namely, a pair of upper rollers 324 and a pair of middle rollers 326, which are placed between the back wall member 312 and the partial front wall members 316; these rollers 324, 326 allow the elevator assembly 320 to move freely vertically while keeping the assembly within the track formed between the front and back wall members 316, 312. The elevator assembly 320 also includes a pair of upper guide rollers 328 and a pair of lower guide rollers 330. The rollers 328, 330 engage the inner surface of the partial front wall members 316 and prevent twisting of the elevator assembly 320.

Springs 340 extend between pins 342 attached to the C-shaped member 310 and pins 344 attached to the elevator assembly 320. The springs 340 assist in overcoming the weight of the work tray 140 and elevator assembly 320. The work tray 140 is supported on the elevator assembly 320 by a pin 350 that extends through openings 352 in brackets 354 that extend outwardly from the plate 322. This arrangement allows the work tray 140 to be rotated from the horizontal position, where arms 356 engage the front wall members 316 of the C-shaped member 310, to a vertical position, for stowage and for vertical repositioning.

The work tray 140 is supported in a selected position by a spring loaded support mechanism 360 which includes a work tray support pin 362, a spring 364 to bias the pin 362 toward the slots 318 in the back wall member 312, and an arm or link 357 that extends outwardly to an actuating mechanism 370 that is attached to the work tray 140 near or at the midpoint on the pin 350. The actuating mechanism 370 is provided with an arcuate slot 372. A pin 374 of the link 357 extends through the slot 372 while another pin 376 of the link 357 is coupled to the pin 362. Thus, as the work tray 140 is pivoted upwardly toward the vertical position, the end of the slot 372 engages the pin 374 and withdraws the support pin 362 from one of the slots 318 with which the support pin 362 is currently engaged, thereby allowing the vertical elevation of the work tray 140 with respect to the operator's compartment 40 to be changed. After repositioning the work tray 140, the process is reversed and support pin 362 is inserted back into one of the slots 318 to secure the work tray 140 at the new height.

A shaft 380 extends downwardly from the elevator assembly 320. A spring 382 urges the shaft 380 down. The spring biased shaft 380 serves two purposes: the first is to provide a cushion when the elevator assembly 320 reaches the bottom of its travel and is about to engage an end plate 385 at the lower end of the C-shaped member 310; and, the other is to provide additional resistance to the lowering of the work tray 140 in preparation for stowing the work tray 140 in a vertical position.

The C-shaped member 310 is provided with a cap 390 having a downwardly extending lip 392. The work tray 140 is provided with a plate 395 for engagement with the lip 392. As shown in FIG. 5A, the work tray 140 may be stowed in the vertical position by pushing down on the work tray 140, placing the plate 395 behind the lip 392, and allowing the springs 340, 382 to move the work tray 140 up so that the plate 395 is trapped behind the lip 392. For removal from the stowed position, the work tray 140 is pushed down against the force of the springs 340, 382 and pivoted downwardly to one of its horizontal service positions along central panel 134.

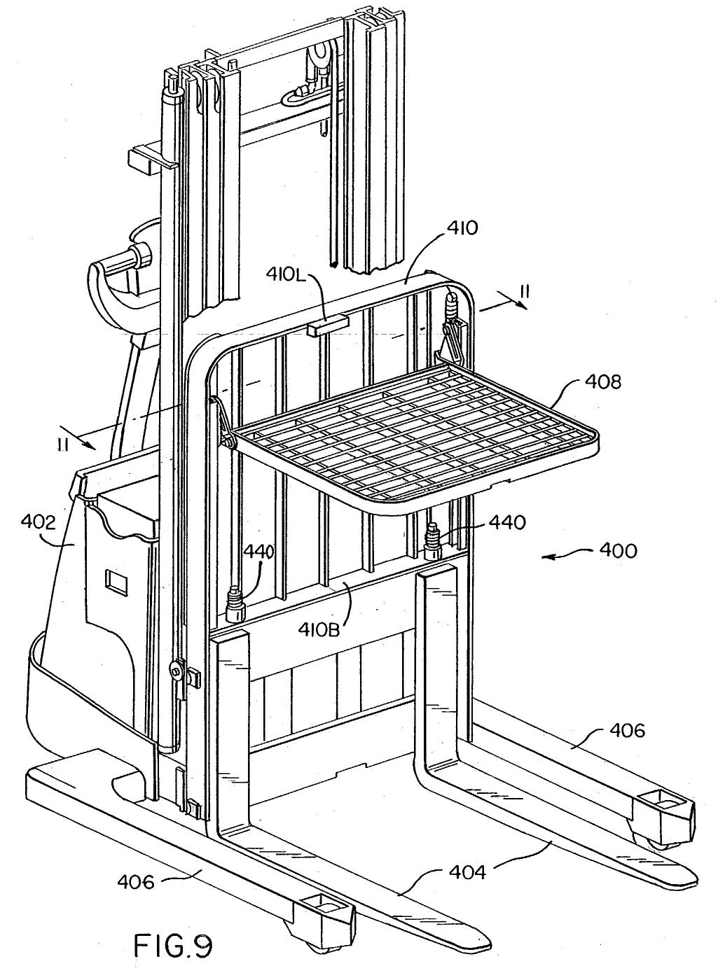

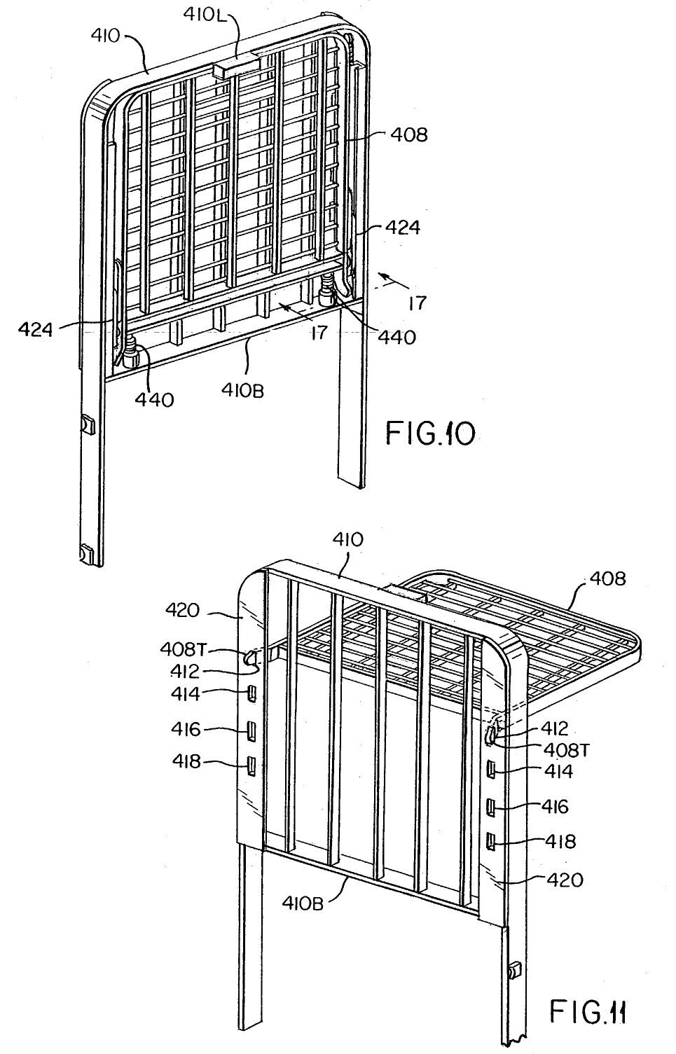

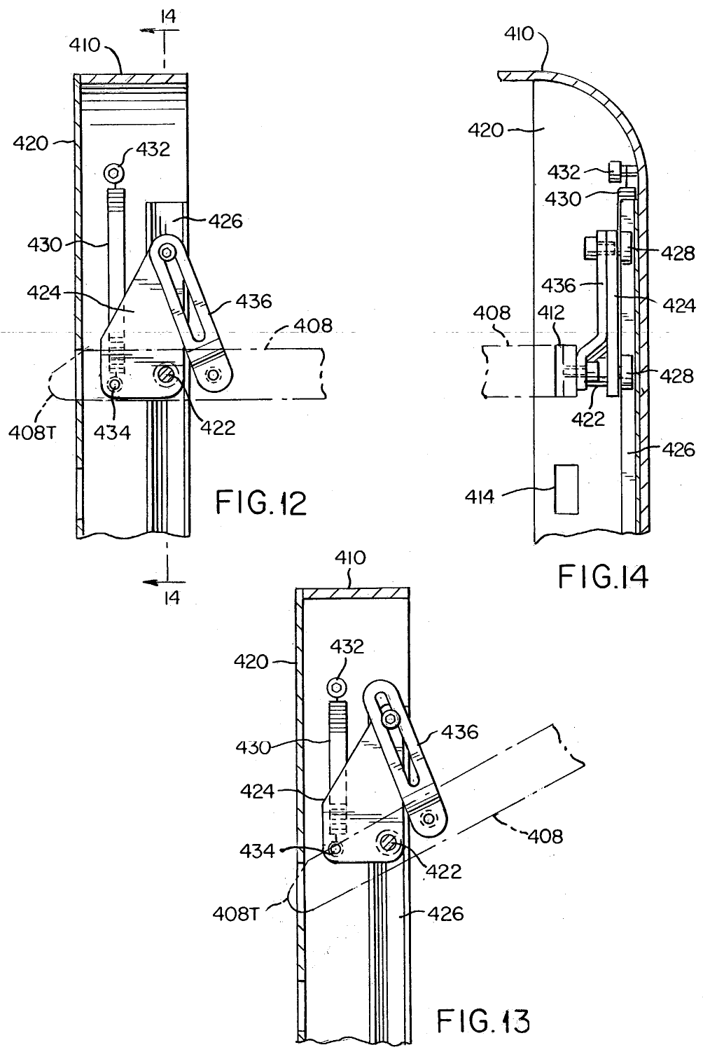

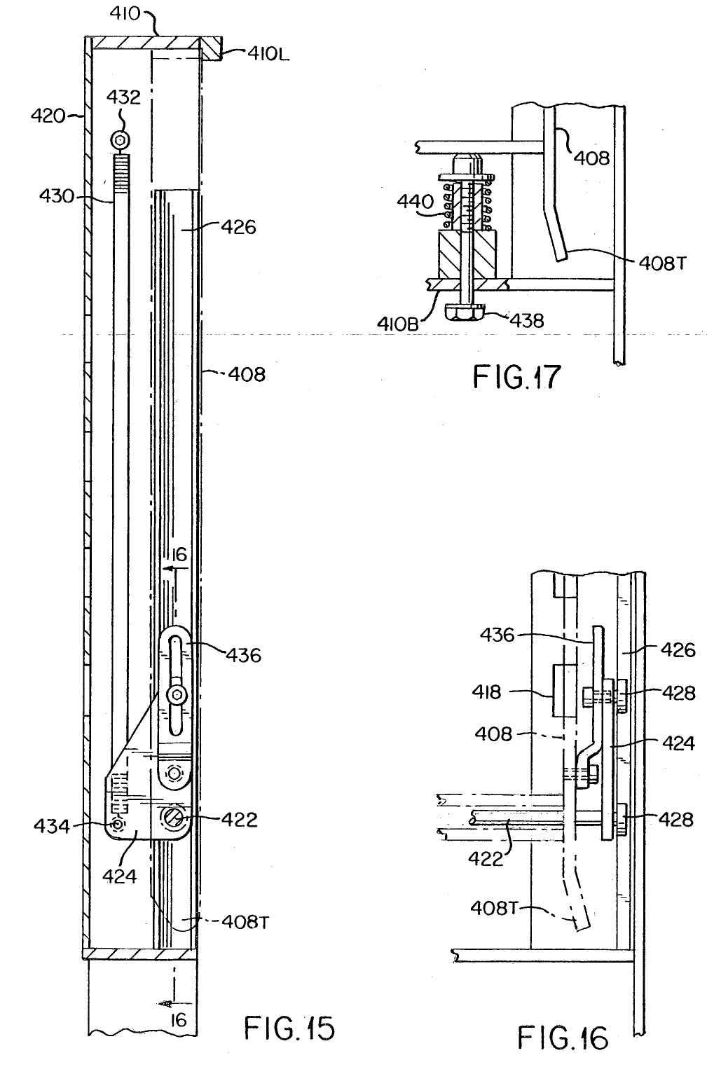

A third embodiment of the present invention is incorporated into a powered pallet truck, illustrated as a walkie stacker pallet truck 400 in FIG. 9, that includes a power unit or truck body 402 having a pair of elongated forks 404 extending in parallel from the truck body 402 between a pair of straddle arms 406. A work tray 408 is supported on an extension or framework 410 with the tray 408 being mounted for adjustable vertical positioning along the framework 410. As illustrated in FIGS. 9 and 11, the tray 408 is located in its highest of four possible positions defined by openings 412, 414, 416, 418 in the panels 420 that are secured to the framework 410 by welding or otherwise. It is to be understood that the work tray 408 can be positioned into four positions defined by the openings 412-418 in the illustrated embodiment of FIG. 9; however, the present invention contemplates any reasonable number of positions greater or less than four and also a continuously positionable mounting arrangement for the tray 408.

The illustrated work tray 408 is mounted to be pivotally moved between use positions over the forks 404 of the truck 400, as shown in FIG. 9, and a stowed position out of the way of the forks 404, as shown in FIG. 10. In the stowed position, the work tray 408 is secured behind a latch 410L. The work tray 408 can be used as described above with reference to the work tray 140 and is pivoted about a rod 422 that extends between a pair of brackets 424 running along channels 426 defined on each side of the framework 410. Each of the brackets 424 is supported on a pair of guide rollers 428 that run within the channels 426 to allow the brackets 424 to move freely vertically while preventing horizontal movement and twisting of the work tray 408.

Springs 430 extend between pins 432 attached to the framework 410 and pins 434 attached to the brackets 424. The springs 430 assist in overcoming the weight of the work tray 408 and associated support apparatus. The work tray 408 is supported on the framework 410 by tip ends 408T of the frame of the work tray 408 that extend through openings 412-418 in the panels 420 secured to the framework 410. Thus, the work tray 408 can be rotated from the horizontal position, where the tip ends 408T engage the openings 412-418 in the panels 420, to a vertical position, for stowage and for vertical repositioning. When in the horizontal position, the work tray 408 is supported by the rod 422, the guide rollers/channels 428, 426, the lost motion links 436 connected between the work tray 408 and the brackets 424. The lost motion links 436 also enable the pivotal movement of the work tray 408 about the rod 422.

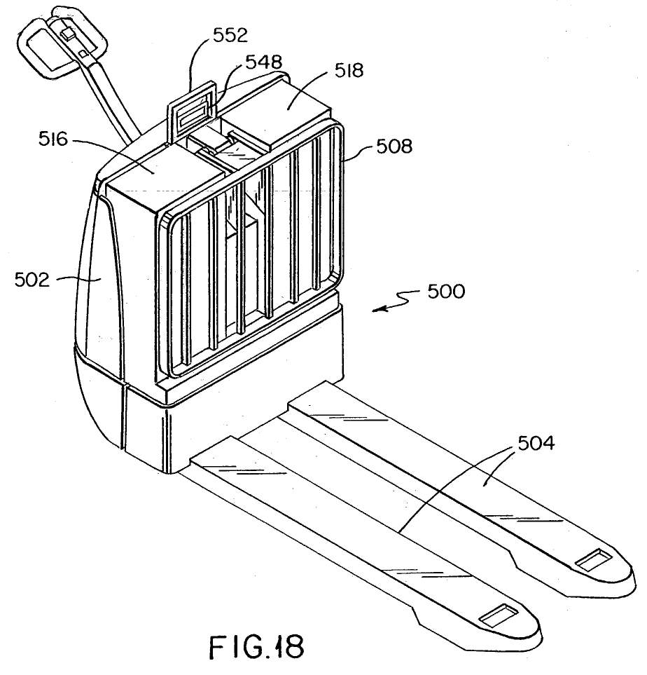

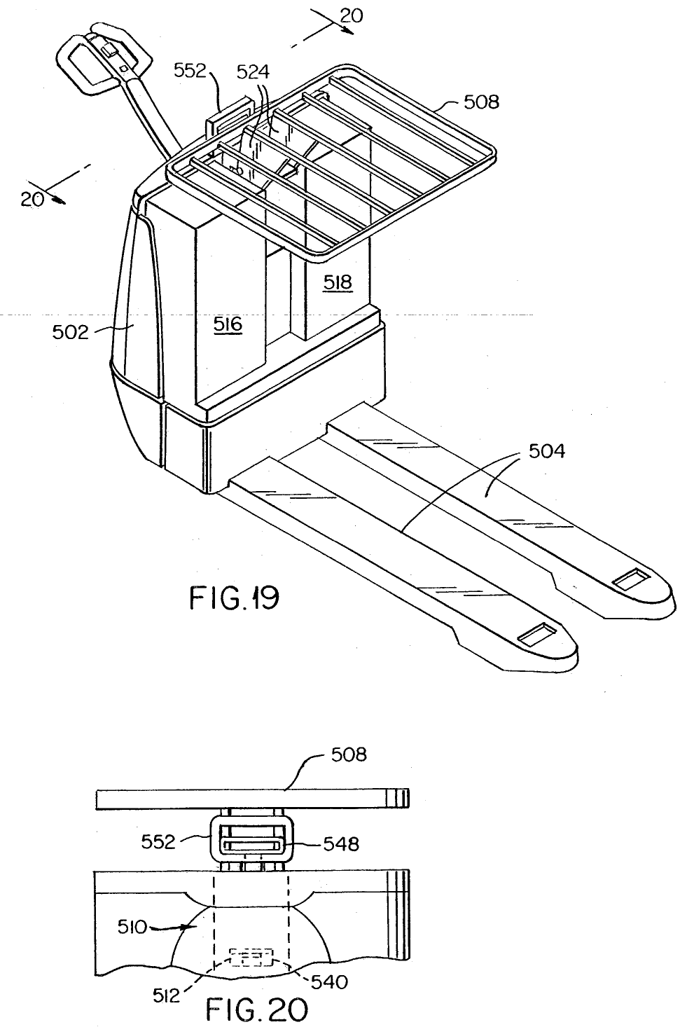

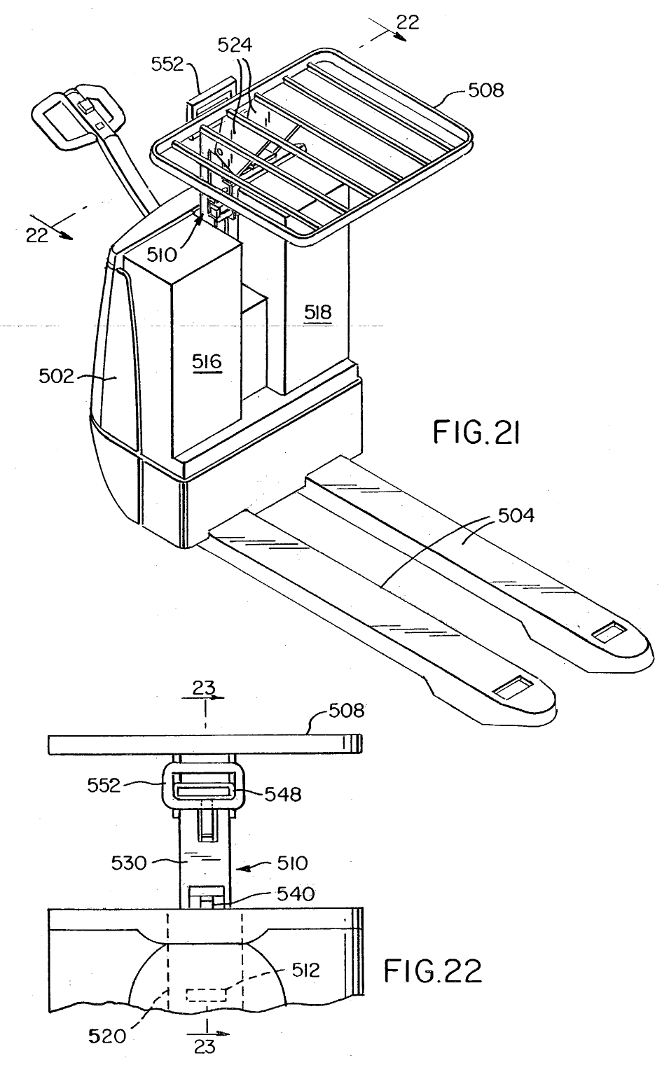

Bolts 438 (two illustrated, although any reasonable number can be provided) extend through a bottom rail 410B of the framework 410 with each bolt 438 including a spring 440 that urges the bolts 438 upward as shown in FIGS. 9 and 17 to form bumpers. The spring biased bolts 438 serve two purposes: the first is to provide a cushion when the work tray 408 reaches the bottom of its travel and is about to engage the bottom rail 410B of the framework 410; and, the other is to provide an upward force for locking the work tray 408 in its vertical, stowed position.

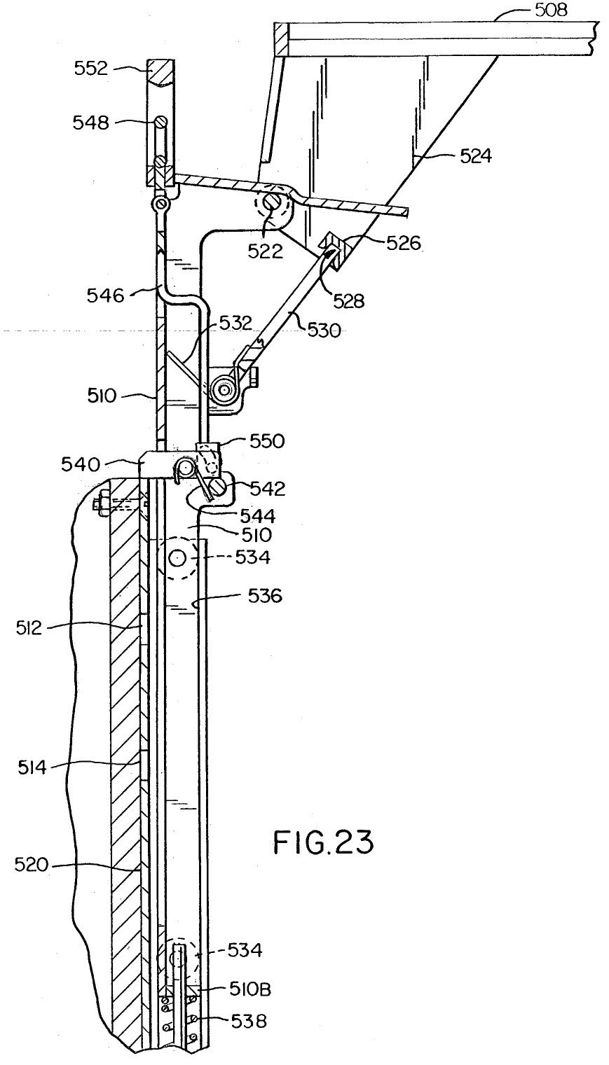

A fourth embodiment of the present invention is incorporated into a powered pallet truck, illustrated as a walkie pallet truck 500 in FIGS. 18, 19 and 21, that includes a power unit or truck body 502 having a pair of elongated forks 504 extending in parallel from the truck body 502. A work tray 508 is supported on an extension taking the form of a mast 510 which is mounted for adjustable vertical positioning relative to the truck body 502 for vertically positioning the tray 508 at desired locations. The mast 510 is mounted between two battery compartments 516,518 located on opposite sides of the truck 500. As illustrated in FIG. 23, the tray 508 is located in its highest position of a number of possible positions defined by the top of a panel 520 and openings 512, 514 (only two shown) in the panel 520 that is secured to the truck body 502. It is to be understood that the work tray 508 can be positioned into three positions defined by the top of the panel 520 and the openings 512, 514 in the illustrated embodiment of FIG. 23; however, the present invention contemplates any reasonable number of positions more or less than three and also a continuously positionable mounting arrangement for the tray 508.

The illustrated work tray 508 is mounted to be pivotally moved between use positions over the forks 504 of the truck 500, as shown in FIGS. 19 and 21, and a stowed position out of the way of the forks 504, as shown in FIG. 18, where the work tray 508 is folded down against the truck body 502 and can also serve as a load backstop in appropriate applications of the truck 500. The work tray 508 can be used as described above with regard to the work tray 140 and is pivoted about a rod 522 that extends between a pair of brackets 524 to which the work tray 508 is secured, for example by welding. A tray latching member 526 extends between the brackets 524 and defines a latching channel 528 that is engaged by a pivotally mounted latch bar 530 that is biased toward the latching member 526 by a spring 532. For this structure, the tray 508 is pivoted until the tray latching bar 530 engages the channel 528 to support the tray 508 in its raised position. To lower the tray 508, the tray 508 is pivoted while the latching bar 530 is manually forced back against the spring 532 out of the channel 528 and the tray 508 is then lowered into its stowed position.

The mast 510 includes a pair of guide rollers 534 that run within channels 536 mounted to the truck body 502 and the battery compartments 516, 518 in the illustrated embodiment to allow the mast 510 to move freely vertically while preventing horizontal movement and twisting of the mast 510 and the work tray 508. One or more springs 538 extend between the bottom 510B of the mast 510 toward the bottom of the mast compartment (not shown) to serve as a bumper and to assist in supporting the weight of the mast 510, work tray 508 and associated support apparatus. Openings (not shown) may be formed in the forward edge of the work tray 508 to receive projections (not shown) on the portion of the truck body 502 that engages the tray 508 when the tray 508 is in its stowed position if desired to secure the tray in its stowed position. The mast 510 is supported at various heights on the truck body 502 by a pivotally mounted bar 540 that engages one of the top of the panel 520 or the openings 512, 514 to define vertical positions of the mast 510 and thereby vertical positions of the work tray 508 relative to the truck body 502. The bar 540 is biased to rest against a rod 542 by a spring 544. A linkage 546 extends between a release handle 548 and a lost motion release block 550 which engages a pin within the bar 540. A mast control handle 552 is provided for raising the mast 510, to assist when an operator operates the release handle 548 and also to shield the release handle 548.

The handle 552 is raised if the mast 510 is to be raised with the bar 540 being pivoted downward and out of the opening which it currently occupies against the force of the spring 544. The bar 540 is then forced into the next higher opening or above the top of the panel 520 as the mast 510 is raised. If the mast 510 is to be lowered, the mast 510 is initially raised and the release handle 548 is pulled to pivot the bar 540 downward so that it can pass by the top of the panel 520 and/or one of the openings 512, 514.

Having thus described the invention of the present application in detail and by reference to illustrative embodiments thereof, it will be apparent that modifications and variations are possible without departing from the scope of the invention defined in the appended claims.

What is claimed is:

1. A hand pallet truck comprising:
a frame assembly;
elongated forks extending in parallel from said frame assembly;
an extension projecting in a general upright direction from said frame assembly; and
a work tray supported on said extension and extending over said elongated forks.

2. A hand pallet truck as claimed in claim 1 wherein said extension is integral with said frame assembly.

3. A hand pallet truck as claimed in claim 1 wherein said extension is secured to said frame assembly.

4. A hand pallet truck as claimed in claim 1 wherein said extension is an add-on accessory for attachment to said frame assembly.

5. A hand pallet truck as claimed in claim 1 wherein said tray can be moved between a use position extending over said elongated forks and a stowed position generally perpendicular to said elongated forks and along said extension.

6. A hand pallet truck as claimed in claim 1 wherein said tray can be moved along said extension to select the height of said tray relative to said elongated forks.

7. A hand pallet truck as claimed in claim 1 wherein said extension comprises:
an outer tubular framework; and
a central panel secured between a major portion of said tubular framework.

8. A hand pallet truck as claimed in claim 7 further comprising item retention apparatus secured to said extension.

9. A hand pallet truck as claimed in claim 8 wherein said item retention apparatus is secured to said central panel.

10. A hand pallet truck as claimed in claim 8 wherein said item retention apparatus is secured to said outer tubular framework.

11. An add-on accessory for a hand pallet truck having a frame assembly and elongated forks extending in parallel from said frame assembly, said accessory comprising:
an extension projecting in a general upright direction from said frame assembly; and
a work tray supported on said extension and extending over said elongated forks.

12. An add-on accessory for a hand pallet truck as claimed in claim 11 wherein said extension includes mounting structure for securing said extension to said truck.

13. An add-on accessory for a hand pallet truck as claimed in claim 11 wherein said tray can be moved between a use position extending over said elongated forks and a stowed position generally perpendicular to said elongated forks and along said extension.

14. An add-on accessory for a hand pallet truck as claimed in claim 11 wherein said tray can be moved along said extension to select the height of said tray relative to said elongated forks.

15. An add-on accessory for a hand pallet truck as claimed in claim 11 wherein said extension comprises:
an outer tubular framework; and
a central panel secured between a major portion of said tubular framework.

16. An add-on accessory for a hand pallet truck as claimed in claim 15 further comprising item retention apparatus secured to said extension.

17. An add-on accessory for a hand pallet truck as claimed in claim 16 wherein said item retention apparatus is secured to said central panel.

18. An add-on accessory for a hand pallet truck as claimed in claim 16 wherein said item retention apparatus is secured to said outer tubular framework.

19. A pallet truck comprising:
a truck body;
elongated forks extending in parallel from said truck body;
an extension attached to said truck body and projecting in a general upright direction adjacent to said elongated forks; and
a work tray supported on said extension and extending over said elongated forks.

20. A pallet truck as claimed in claim 19 wherein said extension is an add-on accessory for attachment to said truck body.

21. A pallet truck as claimed in claim 19 wherein said tray can be moved between a use position extending over said elongated forks and a stowed position generally perpendicular to said elongated forks.

22. A pallet truck as claimed in claim 19 wherein said tray can be moved along said extension to select the height of said tray relative to said elongated forks.

23. A pallet truck as claimed in claim 19 wherein said extension comprises a mast and said mast can be extended relative to said truck body to select the height of said tray relative to said elongated forks.

24. An add-on accessory for a pallet truck having a truck body and elongated forks extending in parallel from said truck body, said accessory comprising:
an extension projecting in a general upright direction from said truck body; and
a work tray supported on said extension and extending over said elongated forks.
